(19) United States
(12) Patent Application Publication
(10) Pub. No.: US 2012/0306343 A1
(43) Pub. Date: Dec. 6, 2012

(54) LIGHT DEVICE

(76) Inventors: Cheng-Kuang Wu, Carmona (PH); Po-Cheng Yang, Taoyuan Shien (CN)

(21) Appl. No.: 13/577,521

(22) PCT Filed: Feb. 1, 2011
(86) PCT No.: PCT/PH11/00001

§ 371 Date: Aug. 7, 2012

(30) Foreign Application Priority Data
Feb. 8, 2010 (PH) 1-2010-000036

(51) Int. Cl. H05B 33/04; H05B 33/08

(52) U.S. Cl. 313/46; 313/512

(57) ABSTRACT

An improved light device comprising a LED having opposing terminal elements for connection to the terminal elements of a power supply, and an inner glass sleeve and/or globe encapsulating the LED, so that the terminal elements of the LED and the terminal elements of the power supply could be tightly fastened together matching the center case of the device and eliminating the usual practice of soldering process.

This invention relates in general to lighting devices but more particularly an improved LIGHT EMITTING DIODE (LED) light source.

A light-emitting diode (LED) is a semiconductor light source. Introduced as a practical electronic component in 1962 early LEDs emitted low-intensity red light, but modern versions are available across the visible, ultraviolet and infrared wavelengths, with very high brightness.

They also enjoy use in applications as diverse as replacements for traditional light sources in automotive lighting (particularly indicators) and in traffic signals. The compact size of LEDs has allowed new text and video displays and sensors to be developed, while their high switching rates are useful in advanced communications technology.

However, LEDs are subject to very limited wear and tear if operated at low currents and at low temperatures. Typical lifetimes quoted are 25,000 to 100,000 hours but heat and current settings can extend or shorten this time significantly.

Moreover, the common electric wiring to connect the LED light source with the electric power supply is using the soldering process. This is quite cumbersome, time consuming and requires skill so that light source undergone by this process is expensive.

It is the primary object of the present invention to provide an improved light device wherein the two terminals of LED can be tightly fastened to the terminals of the power supply by an inner glass sleeve and/or glove matching the center core of this device. There is no need for the conventional solder processing a LED assembly. The sleeve having an O-ring for tight sealing to eliminate moisture thereon.

Another object is to provide an improved light device having a heat absorbing means coupled to the LED that absorbs heat emanated by LED to prolong the service life of the light bulb, wherein the heat absorbing means is metallic, preferably aluminum rod, and this rod is connected by a spring element to a base so that when the rod absorbs the heat from the LED, it becomes heated and would expand, compressing the spring and sink to the direction of its base so that the light bulb has a “heat sink” design.

Still an object is to provide a light device wherein the light bulb being enclosed within a inner glass sleeve and/or glove, being applied with surface treatment at its inner and outer surfaces, so that light distribution can be dispersed homogeneously.

These and other objects and advantages of the present invention would be apparent upon reading the following detailed description taken in conjunction with the appended drawings wherein:

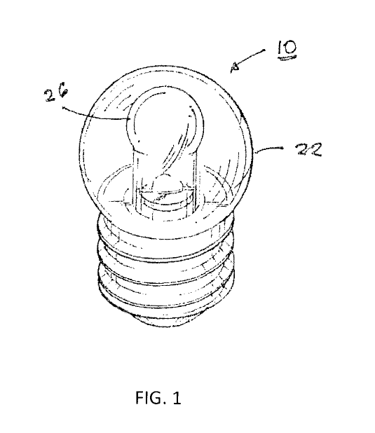

FIG. 1 is a perspective view of the present invention for a lighting device; and

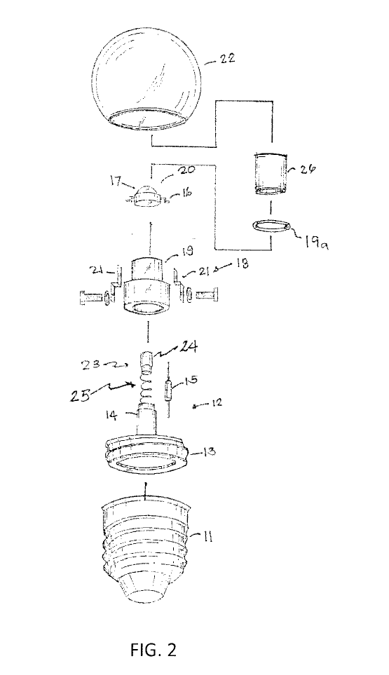

FIG. 2 is an exploded view of the same.

With reference to the several views of the drawings, the present light device 10 comprises a base cap 11 adapted to be screwably attached to a receptacle (not shown) of a household power supply for electrical connection of the lighting device.

A contact parts assembly 12 includes a threaded base 13 adapted to be screwably secured within the base cap 11, a heat absorbing means 23 which consists of a support post 14 fixedly mounted on the threaded base 13, and an electrical element 15 disposed on the base 13 for contact between the base cap 11 and the terminal elements 16 of the LED 17, a metallic rod 24 supported by spring element 25 at the tip of the support post 14 so that it is spring-biased thereon. The tip 26 of this metallic rod 24 abuts the bottom portion 27 of the LED. This is so, so that when the LED begins to emit light, it emits heat and the heat is transferred to the metallic rod 24. When the rod 24 becomes hot, it expands downward, compressing the spring element 25 and the LED 17 begins to sink creating a “heat sink” effect on the lighting device.

The “heat sink” design is coupled with the screw-thread disk to be able to tightly match and to screw with the lamp base cap.

A terminal connection assembly 18 is mounted over the contact parts assembly 12 and includes a tube 19 inserted on the support post 14 of the contact parts assembly 12, a pair of opposed terminal elements 21 are bolted on the opposed sides of said tube 19, and a LED 17 mounted over said tube 19. Said LED 17 having opposing terminal elements 16 for connection to the terminal elements 21 and to a power supply. An inner glass sleeve and/or glove 26 shrouds the LED enabling the terminal elements of the LED and the terminal elements 21 leading to a power supply to be in contact with each other. With the inner glass sleeve, an air tight seal can be easily done with a simple rubber or O-ring 19a to protect LED light source from moisture and/or other elements.

The glass sleeve and/or glove 26 are applied with surface treatment at both surfaces thereof so that light distribution can be dispersed homogeneously. The surface treatment can be glass frosting, painting and/or fine particle coating. Fine particle coating includes electric-static silica coating and electric-static titanium oxide coating. Two layers of light dispersing diffuser are created.

A glass envelop 22 is provided to encapsulate the LED on the base cap 11.

The inner glass sleeve and/or glove is fused together with the outer glass envelope as a single piece of glass jacket, this single piece of glass jacket can be precisely aligned in glass making process for mounting the LED with the electrical and mechanical components exactly at the design location of the lamp.

While the invention has been described in detail with reference to preferred embodiments thereof, it will be apparent to one skilled in the art that various changes can be made, and equivalents employed, without departing from the scope of the invention.

1. An improved light device comprising a LED having opposing terminal elements for connection to the terminal elements of a power supply, and an inner glass sleeve and/or glove encapsulating the LED, so that the terminal elements of the LED and the terminal elements of the power supply could be tightly fastened together matching the center case of the device and eliminating the usual practice of soldering process.

2. An improved light device as in claim 1 wherein a said inner sleeve and/or glove having a simple rubber or O-ring at its bottom portion providing an air tight seal to protect LED light source from moisture and/ or other elements.

3. An improved light device as in claim 1 wherein heat absorbing means is provided which consists of a spring-biased metallic rod, its tip abutting the bottom portion of the LED so that when the rod absorbs the heat emitted by the LED, the rod would sink downward creating a “heat sink” design.

4. An improved light device as in claim 1 wherein said inner glass sleeve and/or glove is surface treated at the inner and/or outer surfaces thereof so that light distribution can be dispersed homogeneously.

5. An improved light device as in claim 4 wherein the surface treatment is glass frosting.

6. An improved light device as in claim 5 wherein the surface treatment is painting.

7. An improved light device as in claim 6 wherein the surface treatment is fine particle coating, such as electric-static silica coating, electric-static titanium oxide coating.

8. An improved light device as in claim 4 wherein the inner glass sleeve and/or glove is fused together with the outer glass envelope as a single piece of glass jacket, this single piece of glass jacket can be precisely aligned in glass making process for mounting the LED with the electrical and mechanical components exactly at the design location of the lamp.

9. An improved light device as in claim 3 wherein “heat sink” design is coupled with the screw-thread disk to be able to tightly match and to screw with the lamp base cap.
